(19) United States
(12) Patent Application Publication
(10) Pub. No.: US 2024/0252384 A1
(43) Pub. Date: Aug. 1, 2024

(54) HAND-HELD MASSAGER

(71) Applicant: Dongguan Mengma Electronic Technology Co., Ltd., Dongguan City (CN)

(72) Inventor: Dongtao Zhou, Dongguan City (CN)

(21) Appl. No.: 18/630,775

(22) Filed: Apr. 9, 2024

(30) Foreign Application Priority Data
Feb. 28, 2024 (CN) 202420383185.8

(51) Int. Cl. A61H 7/00; A61H 23/02

(52) U.S. Cl. CPC A61H 7/008; A61H 7/005; A61H 23/02; A61H 2201/123; A61H 2201/1669; A61H 2201/1673; A61H 2201/169

(57) ABSTRACT

The present invention discloses a hand-held massager, including a housing, two movable sheets and a flexible massage sleeve covering the movable sheets, where a driving mechanism for controlling the two movable sheets to move oppositely and a linkage driving apparatus for driving the driving mechanism to move are arranged in an inner cavity of the housing; and the linkage driving apparatus drives the two movable sheets by the driving mechanism to swing back and forth in opposite directions, so that two opposite side walls on the flexible massage sleeve have a state of being close to each other and a state of being away from each other, thereby performing a pinch type massage on parts required to be massaged.

### TECHNICAL FIELD

The present invention belongs to the technical field of massage health-care devices, and in particular, relates to a hand-held massager.

### BACKGROUND

Massage is to directly act on special parts of the surface of human body so as to stimulate the nerves of the massaged parts of the human body and relax the tense muscles, thereby relieving fatigue and soreness. The traditional massage method is generally to massage parts required to be massaged by hands of massaging professionals in a massage therapy center. However, with the development of the times, a mechanical automatic massage mechanism is generated in the prior art, for example, a leg massage mechanism and a massage chair with the same disclosed by the Chinese utility model patent CN205626431U, but this kind of massage mechanism is suitable for being used on massage chairs, and thus is bulky and inconvenient to carry out.

### SUMMARY

The present invention is a hand-held massager designed to solve the above technical problem.

The hand-held massager designed by the present invention includes:
a housing;
two opposite movable sheets arranged at intervals, each of the movable sheets being at least partially located in an inner cavity of the housing, so that rotary connection parts of the movable sheets are rotatably connected to an inner wall of the housing; and
flexible massage sleeves covering the movable sheets, and
where a driving mechanism for driving the two movable sheets to move oppositely is arranged in the inner cavity of the housing, the driving mechanism includes a linkage driving apparatus and a linear motion piece, motion control parts of the two movable sheets are respectively in transmission connection with a motion output part of the linear motion piece, and the linkage driving apparatus drives the linear motion piece to do a linear reciprocating motion to drive the motion control parts of the movable sheets to swing back and forth, thereby driving the two movable sheets to swing in opposite directions, so that two opposite side walls of the flexible massage sleeves have a state of being close to each other and a state of being away from each other, or inner side walls of the flexible massage sleeves on the two movable sheets have a state of being close to each other and a state of being away from each other, thereby performing a pinch type massage.

The hand-held massager designed by the present invention has the following beneficial effects:

1. The hand-held massager of the present invention has a small size and is convenient to carry out; and meanwhile, the two movable sheets are driven by the action of the linkage driving apparatus and the driving mechanism to swing back and forth in opposite directions, so that the two opposite side walls on the flexible massage sleeve are close to and away from each other, or the inner side walls of the flexible massage sleeves on the two movable sheets are close to or away from each other, thereby performing a pinch type massage on the parts required to be massaged.

2. The movable flexible massage piece is arranged inside flexible massage sleeve in the hand-held massager, and the vibration motor is arranged in the flexible massage piece, so that the flexible massage piece can perform a vibration type massage at different positions of the parts required to be massaged.

3. The suction effect generated by the suction pump enables the flexible massage sleeve to perform a negative pressure type massage on the part to be massaged through the three-way electromagnetic valve and the suction hole, or a continuous vacuum effect is generated in the flexible massage sleeve, so that the flexible sleeve is absorbed at the part required to be massaged, thereby facilitating the vibration type massage or the pinch type massage.

### BRIEF DESCRIPTION OF THE DRAWINGS

FIG. 1 is a schematic diagram of an overall structure;

FIG. 2 is a full cross-sectional view of an overall structure;

FIG. 3 is an enlarged view at a position A;

FIG. 4 is a structural schematic diagram of a massage driving apparatus after a protective sleeve and a flexible massage sleeve are removed;

FIG. 5 is a first schematic diagram of a structure in which a driving mechanism cooperates with a motor in a housing;

FIG. 6 is an enlarged view at a position B;

FIG. 7 is a first exploded view;

FIG. 8 is a second exploded view;

FIG. 9 is a partial cross-sectional view of an overall structure;

FIG. 10 is a second schematic diagram of a structure in which a driving mechanism cooperates with a motor in a housing;

FIG. 11 is a third exploded view;

FIG. 12 is a structural schematic diagram of combination of movable sheets and linkage rods; and

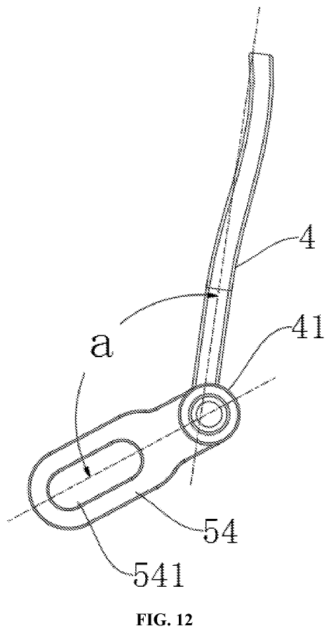

FIG. 13 is a structural schematic diagram of combination of a rotating shaft and an eccentric shaft.

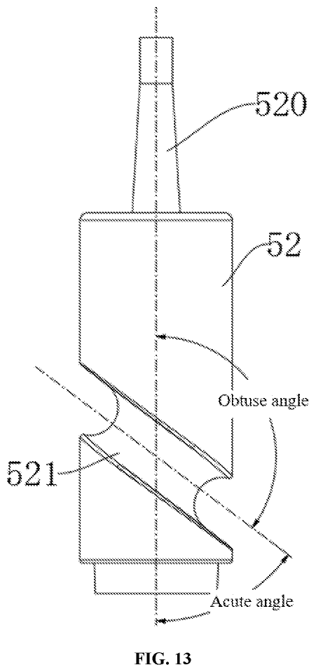

Reference numerals: 1. housing; 11. battery; 12. control panel; 121. button; 13. three-way connector; 14. half housing; 140. through hole; 141. shaft hole; 142. semicircle hole; 143. first through groove; 144. second through groove; 145. third through groove; 146. fourth through groove; 147. first guide groove; 148. suction channel; 149. air channel; 15. three-way electromagnetic valve; 150. penetrating hole; 151. first limiting hole; 152. second limiting hole; 153. second guide groove; 154. first port; 155. second port; 156. third port;
2. flexible massage sleeve; 21. flexible massage piece; 22. suction hole;
3. protective sleeve;
4. movable sheet; 41. rotary connection part; 411. shaft head; 42. curve section; 43. straight section;
5. driving mechanism; 51. linear motion piece; 511. guide protrusion part; 512. guide rail; 513. linkage protrusion part; 52. rotating shaft; 520. eccentric shaft; 521. trajectory groove; 522. circular truncated cone structure; 523. cylinder; 54. linkage rod; 541. elongated hole;
6. linkage driving apparatus; 61. motor;
7. suction pump;
8. movable piece; 81. vibration motor; 82. sphere; 821. insertion hole;
9. sleeve body; 91. inner concave spherical surface; 92. fixing piece; 921. upper limiting body; 922. lower limiting body; 923. middle limiting body.

### DESCRIPTION OF THE EMBODIMENTS

To make those skilled in the art better understand the present invention to define the protection scope of the present invention more clearly, the present invention is described below in detail with reference to some specific embodiments of the present invention.

### Embodiments

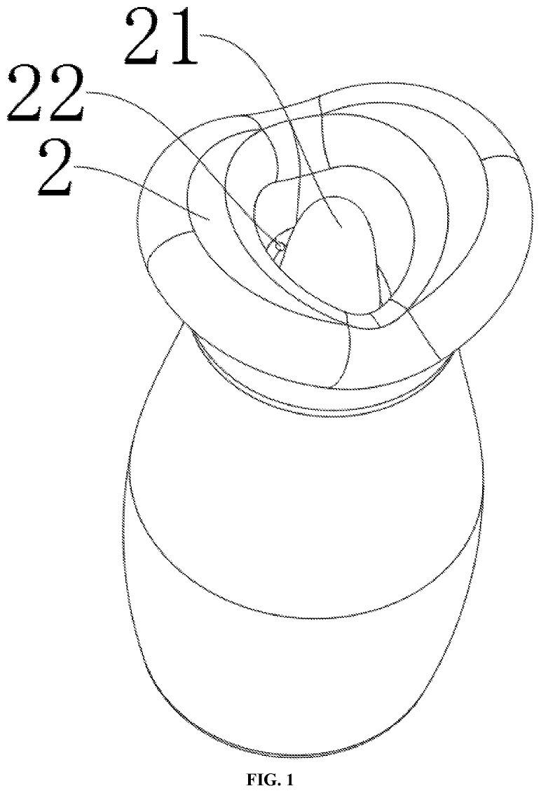

A hand-held massager described in this embodiment includes a housing 1, two movable sheets 4, and flexible massage sleeves 2 covering the movable sheets 4, where the two movable sheets 4 are arranged opposite to each other and at intervals; a driving mechanism 5 for driving the two movable sheets 4 to swing back and forth in opposite directions are arranged in an inner cavity of the housing 1; two penetrating holes 150 arranged at intervals are arranged at an upper end of the housing 1; a lower end of each of the movable sheets 4 passes through the two penetrating holes 150 and enters the inner cavity of the housing 1, so that at least part of each of the movable sheets 4 is located at the inner cavity of the housing 1; furthermore, a rotary connection part 41 of each of the movable sheets 4 is rotatably connected to an inner wall of the housing 1; and a motion control part of each of the movable sheets 4 is in transmission connection with a motion output part of the driving mechanism 5, referring to FIG. 1 to FIG. 4.

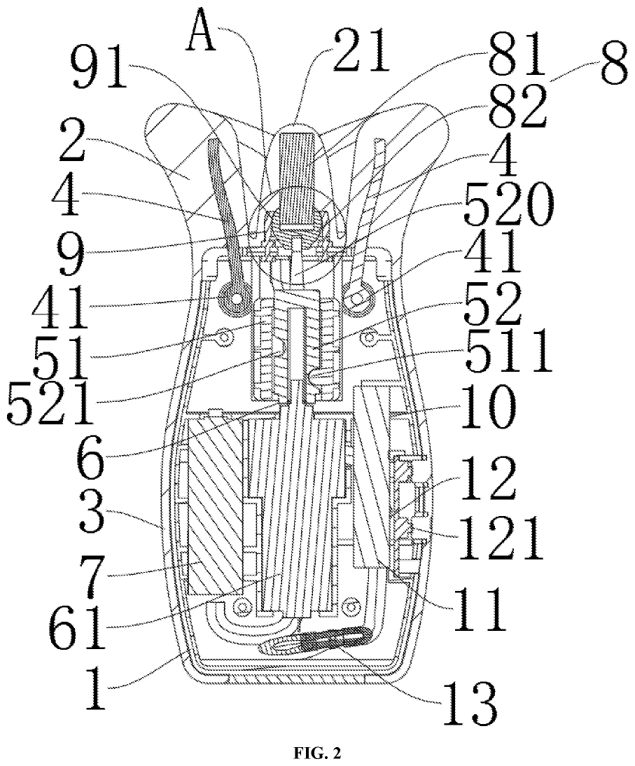

Specifically, the driving mechanism 5 includes a linkage driving apparatus, a linear motion piece 51 and two linkage rods 54, the linkage driving apparatus includes a motor 61 and a rotating shaft 52, and an inclined trajectory groove 521 is formed in a peripheral wall of the rotating shaft 52, so that an obtuse angle and an acute angle are present between an inclined axis of the trajectory groove 521 and a central axis of the rotating shaft 52, where the trajectory groove may be a single spiral trajectory groove, or may be a trajectory groove arranged around the circumference of the rotating shaft and has an annular structure, and this embodiment preferably adopts a trajectory groove with an annular structure. The linear motion piece 51 is located at a side of the rotating shaft 52, and central axes of the linear motion piece and the rotating shaft are arranged in parallel, that is, the linear motion piece 51 is sleeved on the rotating shaft 52; a guide protrusion part 511 is arranged on one side of the linear motion piece 51 facing the rotating shaft 52, and the guide protrusion part 511 is arranged in the trajectory groove 521, so that the linkage driving apparatus 6 is in transmission connection with the linear motion piece 51; a guide structure for guiding the linear reciprocating motion of the linear motion piece 51 is arranged between the linear motion piece 51 and the inner wall of the housing 1; and a rotary shaft of the linkage driving apparatus 6 is connected and fixed with an end part of the rotating shaft 52. Each of the linkage rods 54 is respectively arranged on rotary connection parts 41 of the two movable sheets 4, that is, the linkage rods 54 serve as motion control parts; an elongated hole 541 is formed in each of the linkage rods 54; a linkage protrusion part 513 is arranged on the linear motion piece 51; the elongated hole 541 in each of the linkage rods 54 is sleeved on the linkage protrusion part 513, so that each of the linkage rods 54 is rotatably connected to the linkage protrusion part 513 of the linear motion piece 51, and the motion control parts of the two movable sheets 4 are respectively in transmission connection with the motion output part of the linear motion piece 51; an included angle a is present between the linkage rods 54 and the movable sheets 4 and is an obtuse angle; due to the reasonable design of the included angle, the movable sheets 4 can swing back and forth at a certain angle; and the linear motion piece 51 is made of a plastic material, referring to FIG. 2 to FIG. 4.

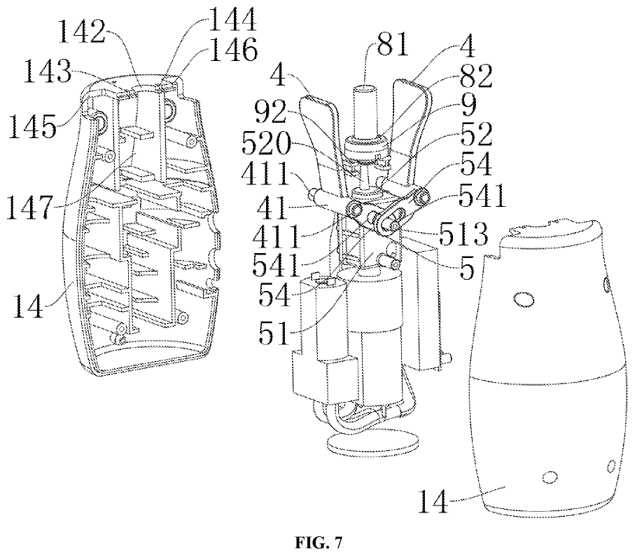

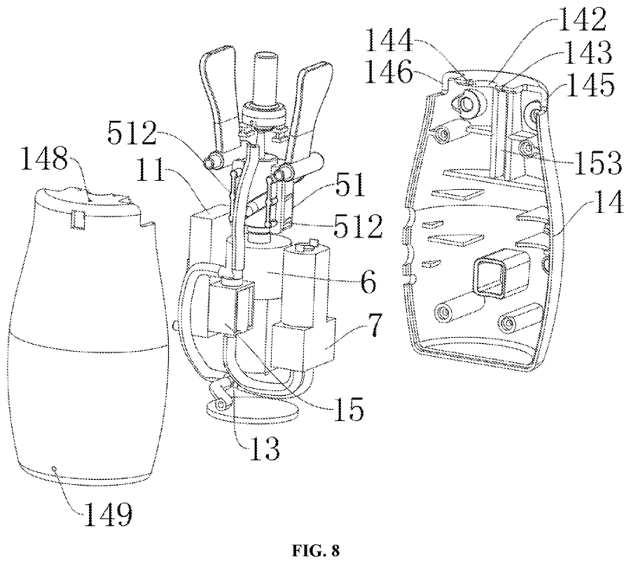

Further, the guide structure includes a first guide groove 147 and a guide rail 512, the guide rail 512 is fitted in the first guide groove 147, and the first guide groove 147 and the guide rail 512 are arranged in a length direction of the housing 1; the first guide groove 147 is formed in the inner wall of the housing 1, the guide rail 512 is arranged on the linear motion piece 51, or the guide rail 512 is arranged on the inner wall of the housing 1, and the first guide groove 147 is arranged on the linear motion piece 51, where the number of the guide rails 512 may be two, the two guide rails 512 are arranged on one side surface of the linear motion piece 51 facing the first guide groove 147, outer side walls of the two guide rails 512 are attached to two opposite inner side walls of the first guide groove 147, but the number of the guide rail 512 may be one, and outer side walls of two opposite sides of the guide rail 512 are respectively attached to two opposite inner side walls in the first guide groove 147, referring to FIG. 7 and FIG. 8.

Preferably, the guide structure further includes a second guide groove 153, the second guide groove 153 is formed in the length direction of the housing 1, and at least part of the linkage protrusion part 513 is fitted in the second guide groove 153, referring to FIG. 7 and FIG. 8.

Therefore, the linear motion piece 51 can be kept to move linearly under the action of the guide structure, and the linear motion piece 51 can move stably and reliably.

In this embodiment, after a motor 61 of the linkage driving apparatus 6 drives the rotating shaft 52 to rotate, the linear motion piece 51 does a linear reciprocating motion under the guide action of the mutual cooperation between the guide protrusion part 511 and the trajectory groove 521 and under the guide action of the guide structure, and at this time, the linkage rods 54 are driven to do reciprocating motion, thereby driving the rotary connection parts 41 and the movable sheets 4 to do reciprocating rotation; and the movable sheets 4 and the linkage rods 54 rotate around the central axes of the rotary connection parts 41, so that the two movable sheets 4 can swing back and forth in opposite directions, two opposite side walls on the flexible massage sleeve 2 have a state of being close to each other and a state of being away from each other, or the inner side walls of the flexible massage sleeves 2 on the two movable sheets 4 have a state of being close to each other and a state of being away from each other, thereby performing a pinch type massage on the massaged parts.

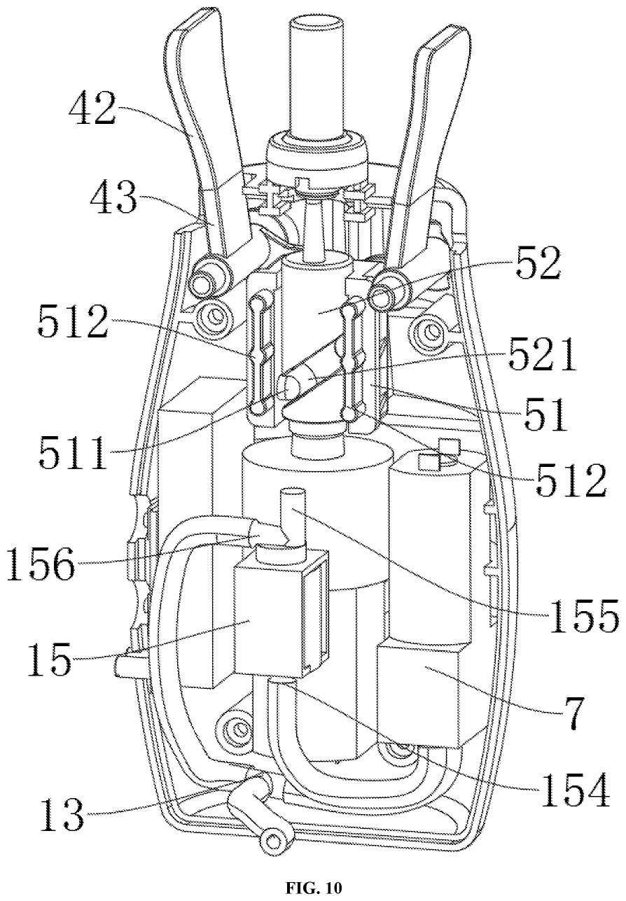

Preferably, each of the movable sheets 4 includes a curve section 42 and a straight section 43, an inner side wall of the curve section 42 is an arc-shaped inner concave side wall, the straight section 43 is connected to a lower end of the curve section 42, and a lower end of the straight section 43 is connected to the rotary connection part 41, referring to FIG. 10.

In this embodiment, the housing 1 is provided with a through hole 140, the position of the through hole 140 corresponds to the position of the upper end of the rotating shaft 52, an eccentric shaft 520 is arranged at the upper end of the rotating shaft 52, a central axis of the eccentric shaft 520 deviates from a central axis of the rotating shaft 52, a movable piece 8 is movably mounted on the housing 1 and at the position of the through hole 140, a flexible massage piece 21 is formed in an inner cavity of the flexible massage sleeve 2, the flexible massage piece 21 is in a protruded state in the inner cavity of the flexible massage sleeve 2, the flexible massage piece 21 is sleeved on the movable piece 8, an upper end of the eccentric shaft 520 is inserted into an insertion hole of the movable piece 8, and the insertion hole of the movable piece 8 is in clearance fit with the upper end of the eccentric shaft 520, where after a massage end part of the flexible massage piece 21 is in contact with a part required to be massaged, the motor 61 of the linkage driving apparatus 6 drives the rotating shaft 52 to rotate and drive the eccentric shaft 520 to do a circular motion, and at this time, the movable piece 8 moves along with the motion of the eccentric shaft 520, so that the flexible massage piece 21 moves to change the massage position and perform massage in a kneading manner, referring to FIG. 1 to FIG. 3 and FIG. 11.

Further, the movable piece 8 includes a vibration motor 81 and a sphere 82, a lower end of the vibration motor 81 is mounted on the sphere 82, the flexible massage piece 21 is sleeved on the vibration motor 81, a sleeve body 9 is mounted on the housing 1 and at the position of the through hole 140, the sphere 82 and the sleeve body 9 are made of a plastic material, the sphere 82 is placed in an inner hole of the sleeve body 9, an inner concave spherical surface 91 is formed on an inner wall of the inner hole of the sleeve body 9, the inner concave spherical surface 91 is continuously arranged in a circumferential direction of the inner hole of the sleeve body 9, an outer spherical surface of an upper part of the sphere 82 is arranged in cooperation with the inner concave spherical surface 91 of the sleeve body 9, the upper end of the eccentric shaft 520 is inserted into the insertion hole at the lower end of the sphere 82, and the position of the insertion hole at the lower end of the sphere 82 deviates from the central axis of the rotating shaft 52, so that the vibration motor 81 and the flexible massage piece 21 are inclined. After the linkage driving apparatus 6 drives the rotating shaft 52 to rotate, the sphere 82 is driven to rotate in the inner hole of the sleeve body 9, and the insertion hole, the vibration motor 81 and the flexible massage piece 21 do a circular motion around the central axis of the rotating shaft 52, so that the flexible massage piece 21 in contact with the part required to be massaged can change the massage position continuously to perform massage in a kneading manner, referring to FIG. 1 to FIG. 3 and FIG. 11.

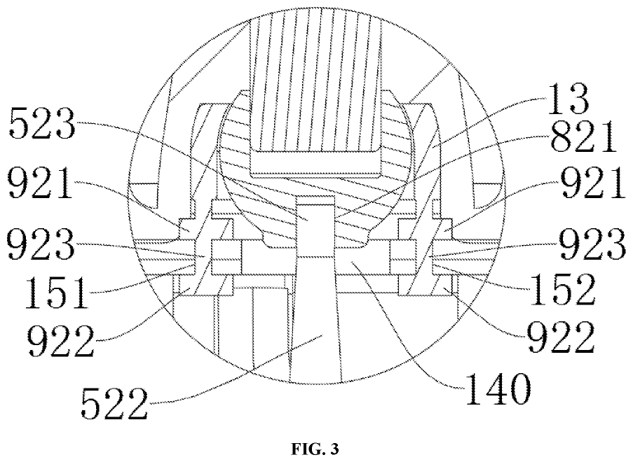

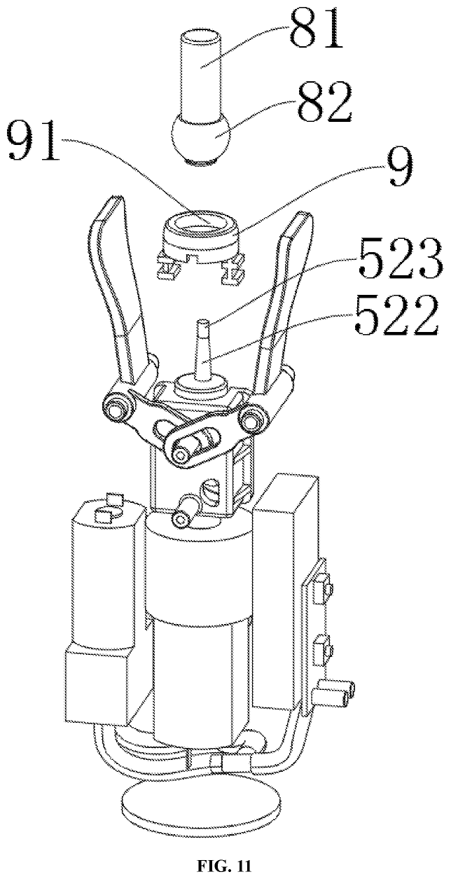

Preferably, the eccentric shaft 520 includes a circular truncated cone structure 522 having a diameter of an upper end less than a diameter of a lower end, and a cylinder 523 located at the upper end of the circular truncated cone structure 522; the cylinder 523 passes through the through hole 140 and is inserted into the insertion hole 821 of the movable piece 8; the circular truncated cone structure 522 and the rotating shaft 52 are combined with each other into an integrated structure; and the arrangement of the circular truncated cone structure 522 is to enhance the connecting strength of the position where the circular truncated cone structure 522 and the rotating shaft 52 are connected, thereby further improving the structural strength of the eccentric shaft 520, referring to FIG. 3 and FIG. 11.

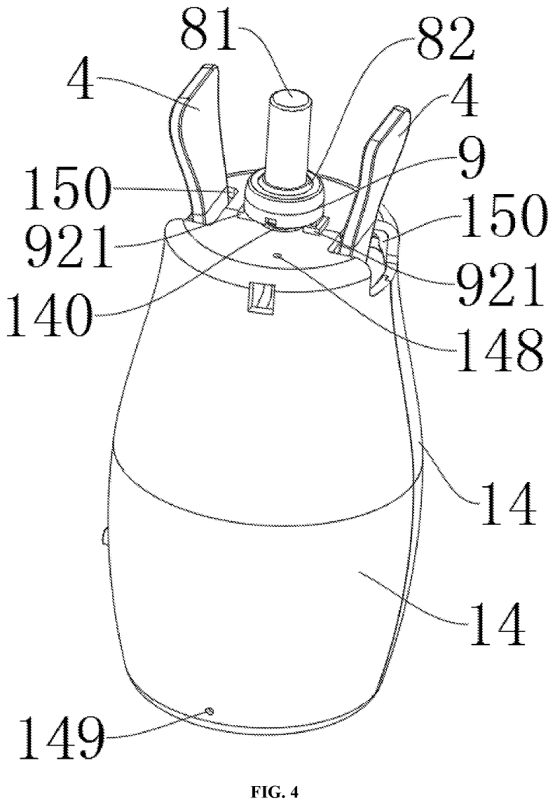

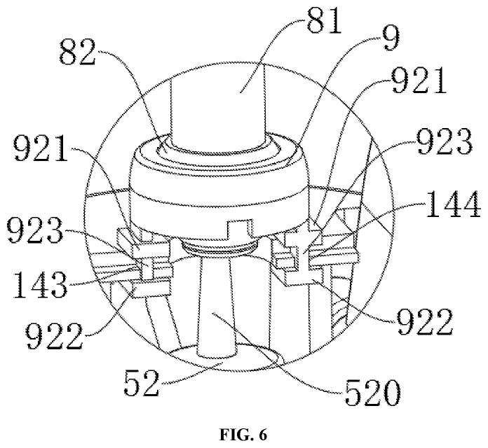

In this embodiment, the housing 1 includes two symmetrical half housings 14, the half housings 14 are made of a plastic material, two opposite fixing pieces 92 are arranged at a lower end of the sleeve body 9, a fixing part of each of the fixing pieces 92 includes an upper limiting body 921, a middle limiting body 923 and a lower limiting body 922, the middle limiting body 923 is located between the upper limiting body 921 and the lower limiting body 922, an upper end of each of the half housings 14 is provided with a semicircle hole 142, a first through groove 143, a second through hole 144, a third through groove 145 and a fourth through groove 146, two through grooves are respectively located on two sides of the semicircle holes 142, the two half housings 14 are mutually symmetrically assembled and fixed, the semicircle holes 142 in the two half housings 14 are assembled to form the through hole 140, the first through grooves 143 in the two half housings 14 are assembled to form a first limiting hole 151, the second through grooves 144 in the two half housings 14 are assembled to form a second limiting hole 152, the middle limiting body 923 of each of the fixing pieces 92 is respectively placed in the first limiting hole 151 and the second limiting hole 152, the third through grooves 145 in the two half housings 14 are assembled to form a penetrating hole 150, the fourth through grooves 146 in the two half housings 14 are assembled to form another penetrating hole 150, the through hole 140, the first limiting hole 151, the second limiting hole 152 and two penetrating holes 150 are located on the same central axis, one penetrating hole 150 is located on an outer side of the first limiting hole 151, the another penetrating hole 150 is located on an outer side of the second limiting hole 152, the upper limiting body 921 is in contact with an outer wall of each of the half housings 14, and the lower limiting body 922 is in contact with an inner wall of each of the half housings 14. Based on the above, when the sleeve body 9 is mounted on the housing 1 and the two half housings 14 are not assembled and connected, one part of each of the two middle limiting bodies 923 is respectively inserted into the first through groove 143 and the second through groove 144 of one half housing 14, then the two half housings 14 are symmetrically assembled, connected and fixed, and the other parts of the two middle limiting bodies 923 are respectively inserted into the first through groove 143 and the second through groove 144 of the other half housing 14, so that the upper limiting body 921 and the lower limiting body 922 are clamped and fitted on the half housings 14, thereby mounting and fixing the sleeve body 9 on the housing 1. The method for mounting the sleeve body 9 is convenient, and the mounting efficiency is improved. The sleeve body 9, the fixing pieces 92, the upper limiting body 921, the middle limiting body 923 and the lower limiting body 922 are combined mutually into an integrated structure, referring to FIG. 4 to FIG. 8.

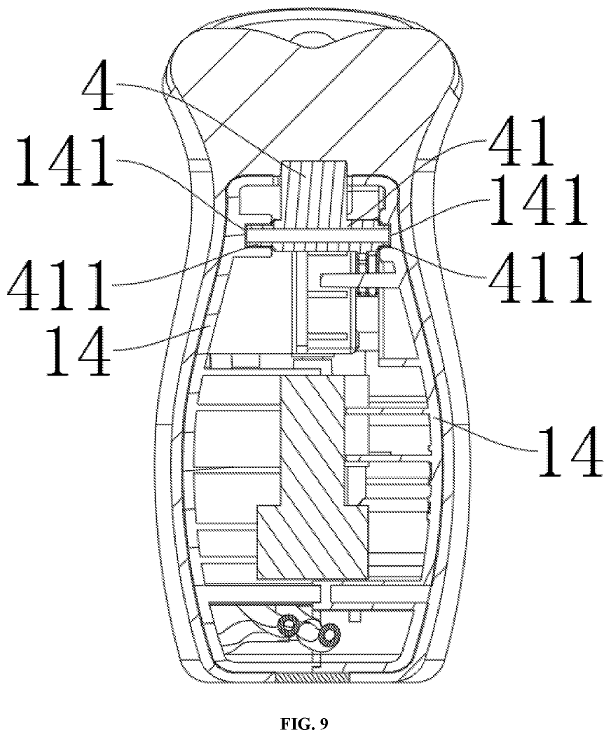

Preferably, shaft heads 411 are arranged at two ends of the rotary connection part 41 of each of the movable sheets 4, inner walls of the two half housings 14 are provided with shaft holes 141 positioned corresponding to each other, each of the shaft heads 411 is respectively inserted into the shaft holes 141 of the two half housings 14, and the rotary connection part 41 of each of the movable sheets 4 has a rotating shaft structure. During mounting, the shaft head 411 at one end of the rotary connection part 41 is inserted into the shaft hole 141 of one half housing 14, and then the two half housings 14 are symmetrically assembled, so that the shaft head 411 at the other end of the rotary connection part 41 is inserted into the shaft hole 141 of the other half housing 14. Finally, the two half housings 14 are fixedly connected through a bolt, referring to FIG. 7 and FIG. 9.

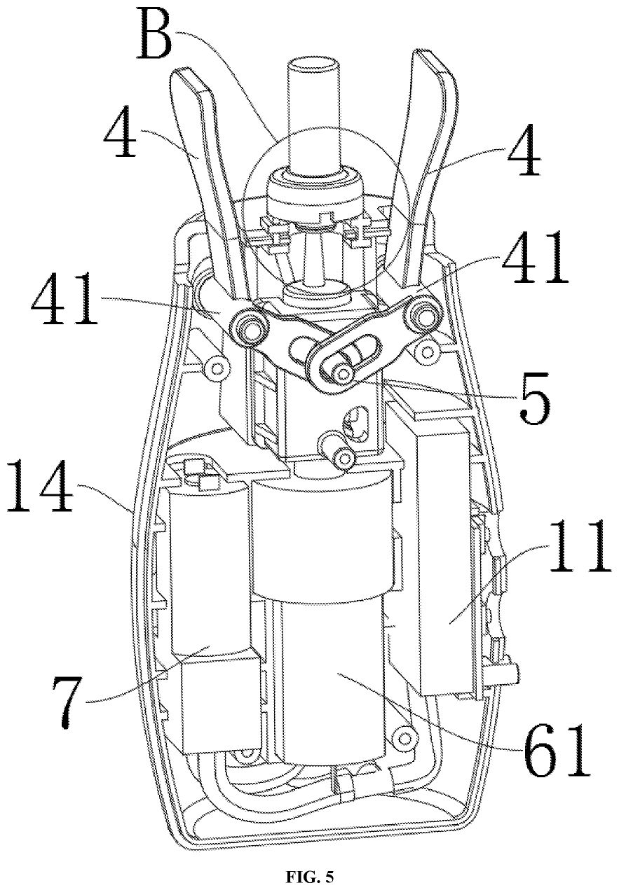

In this embodiment, a three-way electromagnetic valve 15, a suction pump 7 and a three-way connector 13 are arranged in the housing 1, a battery positioning groove 10 is formed in an inner wall of one half housing 14, a battery 11 is mounted in the battery positioning groove 10, and the battery 11 supplies power for the motor 61, the suction pump 7 and the three-way electromagnetic valve 15. The housing 1 is provided with an air channel 149 communicating with the outside, and a suction channel 148 communicating with a suction hole 22 in the flexible massage sleeve 2; a suction port of the suction pump 7 is connected to a first port 154 of the three-way electromagnetic valve 15 through a pipeline; a first branch pipe of the three-way connector 13 is mounted on the air channel 149 or is connected to the air channel 149 through a pipeline; a second port 155 of the three-way electromagnetic valve 15 is connected to the suction channel 148 through a pipeline; an air outlet of the suction pump 7 is connected to a second branch pipe of the three-way connector 13 through a pipeline; a third port 156 of the three-way electromagnetic valve 15 is connected to a third branch pipe of the three-way connector 13 through a pipeline; a control panel 12 is arranged in the inner cavity of the housing 1; a button 121 on the control panel 12 penetrates into the half housings 14; and working programs of the three-way electromagnetic valve 15 and the motor 61 are stored in a control chip on the control panel 12, so the control panel 12 can control power on and power off. When the three-way electromagnetic valve 15 is powered off, the first port and the second port communicate with each other, and the third port is disconnected. At this time, the suction pump 7 works to pump air from the inner cavity of the flexible massage sleeve 2, so that the flexible massage sleeve 2 can perform adsorption after being in contact with the skin of the massaged part, thereby performing a negative pressure type massage. When it is necessary to relieve negative pressure, the three-way electromagnetic valve 15 is powered on, the first port and the third port communicate with each other, and the second port is powered off, so that the external air passes through the air channel 149, the third port, the first port and the suction channel and then enters the inner cavity of the flexible massage sleeve 2, thereby relieving the negative pressure, referring to FIG. 2, FIG. 3, FIG. 5, FIG. 7 and FIG. 8.

In this embodiment, the housing 1 is covered with a protective sleeve 3, the protective sleeve 3, the flexible massage sleeve 2 and the flexible massage piece 21 are combined mutually into an integrated sleeve-shaped structure, and the sleeve-shaped structure is made of a silica gel material.

When the hand-held massager described in this embodiment is used, the two movable sheets 4 can be driven under the state of negative pressure massage to act so as to perform a pinch type massage on the massaged part. Under the working state of the pinch type massage, the rotating shaft 52 will drive the eccentric shaft 520 to rotate so as to drive the vibration motor 81 and the flexible massage piece 21 to do a circular motion at the same time around the central axis of the rotating shaft 52. The flexible massage piece 21 in contact with the massaged part changes the massage position continuously to perform massage in a kneading manner, so that negative pressure massage, pinch type massage and kneading massage are performed at the same time, thereby diversifying the massage functions. Or the pinch type massage and the kneading massage are performed at the same time when the negative pressure massage does not work.

What is claimed is:

1. A hand-held massager, comprising:
a housing;
two opposite movable sheets arranged at intervals, each of the movable sheets being at least partially located in an inner cavity of the housing, so that rotary connection parts of the movable sheets are rotatably connected to an inner wall of the housing; and
flexible massage sleeves covering the movable sheets, and
wherein a driving mechanism for driving the two movable sheets to move oppositely is arranged in the inner cavity of the housing, the driving mechanism comprises a linkage driving apparatus and a linear motion piece, motion control parts of the two movable sheets are respectively in transmission connection with a motion output part of the linear motion piece, and the linkage driving apparatus drives the linear motion piece to do a linear reciprocating motion to drive the motion control parts of the movable sheets to swing back and forth, thereby driving the two movable sheets to swing in opposite directions, so that two opposite side walls of the flexible massage sleeves have a state of being close to each other and a state of being away from each other, or inner side walls of the flexible massage sleeves on the two movable sheets have a state of being close to each other and a state of being away from each other, thereby performing a pinch type massage.

2. The hand-held massager according to claim 1, wherein the linkage driving apparatus comprises a motor and a rotating shaft, the driving mechanism further comprises two linkage rods, an inclined trajectory groove is formed in a peripheral wall of the rotating shaft, the linear motion piece is parallelly arranged at a side of the rotating shaft, a guide protrusion part is arranged on one side of the linear motion piece facing the rotating shaft, the guide protrusion part is arranged in the trajectory groove, a guide structure for the linear motion piece to do a linear reciprocating motion is arranged between the linear motion piece and the inner wall of the housing, and a rotary shaft of the motor is connected and fixed with an end part of the rotating shaft; and each of the linkage rods are respectively arranged on the rotary connection parts of the two movable sheets, an elongated hole is formed in each of the linkage rods, a linkage protrusion part is arranged on the linear motion piece, and the elongated hole of each of the linkage rods is sleeved on the linkage protrusion part.

3. The hand-held massager according to claim 2, wherein an included angle is present between each of the linkage rods and each of the movable sheets, and is an obtuse angle.

4. The hand-held massager according to claim 2, wherein the guide structure comprises a first guide groove and a guide rail; the guide rail is fitted in the first guide groove; the first guide groove and the guide rail are arranged in a length direction of the housing; and
the first guide groove and the guide rail are respectively arranged on the inner wall of the housing and the linear motion piece.

5. The hand-held massager according to claim 4, wherein the guide structure further comprises a second guide groove, the second guide groove is formed in the length direction of the housing, and at least part of the linkage protrusion part is fitted in the second guide groove.

6. The hand-held massager according to claim 2, wherein the housing is provided with a through hole, the position of the through hole corresponds to the position of an upper end of the rotating shaft, the upper end of the rotating shaft is provided with an eccentric shaft, a central axis of the eccentric shaft deviates from the central axis of the rotating shaft, a movable piece is movably mounted on the housing and at the position of the through hole, a flexible massage piece is formed in an inner cavity of the flexible massage sleeve, the flexible massage piece is sleeved on the movable piece, and an upper end of the eccentric shaft is inserted into an insertion hole of the movable piece, and the insertion hole of the movable piece is arranged in clearance fit with the upper end of the eccentric shaft.

7. The hand-held massager according to claim 6, wherein the movable piece comprises a vibration motor and a sphere, a lower end of the vibration motor is mounted on the sphere, the flexible massage piece is sleeved on the vibration motor, a sleeve body is mounted on the housing and at the position of the through hole, the sphere is placed in an inner hole of the sleeve body, an inner concave spherical surface is formed on an inner wall of the inner hole of the sleeve body, the inner concave spherical surface is continuously arranged in a circumferential direction of the inner hole of the sleeve body, an outer spherical surface of an upper part of the sphere is arranged in cooperation with the inner concave spherical surface of the sleeve body, the upper end of the eccentric shaft is inserted into the insertion hole at the lower end of the sphere, and the position of the insertion hole at the lower end of the sphere deviates from the central axis of the rotating shaft, so that the vibration motor and the flexible massage piece are inclined.

8. The hand-held massager according to claim 7, wherein the housing comprises two symmetrical half housings, the lower end of the sleeve body is provided with two opposite fixing pieces, and a fixing part of each of the fixing pieces comprises an upper limiting body, a middle limiting body and a lower limiting body, and the middle limiting body is located between the upper limiting body and the lower limiting body; and
an upper end of each of the half housings is provided with a semicircle hole, a first through groove and a second through groove, the first through groove and the second through groove are respectively located at two sides of the semicircle hole, the two half housings are symmetrically assembled and fixed with each other, the semicircle holes in the two half housings are assembled to form the through hole, the first through grooves in the two half housings are assembled to form a first limiting hole, the second through grooves in the two half housings are assembled to form a second limiting hole, the middle limiting body of each of the fixing pieces is respectively placed in the first limiting hole and the second limiting hole, the upper limiting body is in contact with an outer wall of each of the half housings, and the lower limiting body is in contact with an inner wall of each of the half housings.

9. The hand-held massager according to claim 8, wherein shaft heads are arranged at two ends of the rotary connection part of each of the movable sheets, shaft holes positioned corresponding to each other are arranged on the inner walls of the two half housings, the shaft heads are respectively inserted into the shaft holes of the two half housings, and the rotary connection part of each of the movable sheets is of a rotating shaft structure.

10. The hand-held massager according to claim 1, wherein the housing is internally provided with a three-way electromagnetic valve, a suction pump and a three-way connector, the housing is provided with an air channel communicating with the outside and a suction channel communicating with a suction hole in the flexible massage sleeve, a suction port of the suction pump is connected to a first port of the three-way electromagnetic valve through a pipeline, a first branch pipe of the three-way connector is mounted on the air channel or connected to the air channel through a pipeline, a second port of the three-way electromagnetic valve is connected to the suction channel through a pipeline, an air outlet of the suction pump is connected to a second branch pipe of the three-way connector through a pipeline, and a third port of the three-way electromagnetic valve is connected to a third branch pipe of the three-way connector through a pipeline.

11. A hand-held massager comprising:
a housing extending in a first direction;
at least two movable sheets movably arranged on the housing in a swinging manner about a first pivot shaft arranged in a second direction and serving as a rotary shaft, and arranged oppositely or in an array, the second direction being substantially perpendicular to the first direction;
a flexible massage sleeve covering at least one part of each of the movable sheets to form a flexible massage part; and
a driving mechanism configured to drive the movable sheets to swing and comprising a linkage driving apparatus, a linear motion piece and a linkage rod, the linkage driving apparatus comprising a rotating shaft, the rotating shaft being rotatably and movably arranged about a second pivot shaft arranged in a first direction and serving as a rotary shaft, the rotating shaft being spirally provided with a trajectory groove, the linkage rod being drivingly connected to the movable sheets, the linkage rod being provided with an elongated hole, and the linear motion piece being constrained to be movably arranged in the first direction and in a reciprocating manner and to pass through the trajectory groove and the elongated hole, and
wherein the rotating shaft is driven by the driving mechanism to rotate about a second pivot shaft, thereby driving the linear motion piece to do a reciprocating motion in the first direction, so that the movable sheets do a reciprocating swing motion to perform a pinch type massage.
